(19) United States
(12) Patent Application Publication
(10) Pub. No.: US 2017/0055045 A1
(43) Pub. Date: Feb. 23, 2017

(54) RECOVERING FROM DISCONTINUITIES IN TIME SYNCHRONIZATION IN AUDIO/VIDEO DECODER

(71) Applicant: FREESCALE SEMICONDUCTOR, INC., Austin, TX (US)

(72) Inventor: JIAN LI, Chengdu (CN)

(21) Appl. No.: 15/139,339

(22) Filed: Apr. 27, 2016

(30) Foreign Application Priority Data
Aug. 19, 2015 (CN) 201510625896.7

(51) Int. Cl. H04N 21/8547; H04N 19/503; H04N 21/434; H04N 19/44; H04N 21/43

(52) U.S. Cl. CPC H04N 21/8547; H04N 19/44; H04N 21/4307; H04N 21/4341; H04N 21/4348; H04N 19/503

(57) ABSTRACT

A decoder for decoding compressed video and audio data. The demultiplexer provides a prediction of a presentation timestamp (PTS) after a discontinuity occurs that is conditional on whether data of the elementary bit stream is still present in the demultiplexer and control decoder module when the discontinuity is detected. If data is still present, the prediction is based on extrapolation from a PTS received prior to the discontinuity using a duration of sample data in the elementary bit stream. If data is no longer present in the demultiplexer, the prediction is based on the current time indicated by the local clock extrapolated using a defined latency.

### BACKGROUND

The present invention is directed to data compression and decompression and, more particularly, to recovering from discontinuities in time synchronization in an audio/video decoder.

Data compression is used for reducing the volume of data stored, transmitted or reconstructed (decoded and played back), especially for video content. Decoding recovers the audio and video content from the compressed data in a format suitable for playback. Various standards of formats for encoding and decoding compressed signals efficiently are available. Some standards that are commonly used for moving pictures and associated audio are the International Standards Organization (ISO), International Electrotechnical Commission (IEC) and Moving Picture Experts Group (MPEG) standards, and International Telecommunications Union (ITU) recommendations such as ITU-T H.262|ISO/IEC13818 (MPEG2) and ITU-T H.264, the VPx standards and the VC-1 standard.

In the ISO/IEC13818 (MPEG2) standard, the highest syntactic structure of the coded video bit stream is the video sequence. A video sequence starts with a sequence header that may optionally be followed by a group of pictures header and then by one or more coded frames. The order of the coded frames in the coded bit stream is the order in which the decoder processes them, but not necessarily in the correct order for display.

A Program Map Table, specifies, among other information, which packet identifiers (PIDs), and therefore which elementary streams are associated to form each program. This table also indicates the PID of the Transport Stream packets that carry program clock recovery data (PCR) for each program.

The decoding process for various video compression standards involves decoding the compressed data for the different picture items in the order in which it is received, which may be defined by a decoding timestamp (DTS) in the input transport bit stream, combining the inter-coded and intra-coded items according to the motion vectors or intra-prediction modes, re-ordering the picture items and synchronizing the video data with the audio data for presentation.

In order to achieve the time synchronization between the audio and the video, the input transport bit stream typically also contains a presentation timestamp (PTS). However, discontinuities can occur in the timestamps, for example due to data being dropped during transport (streaming or broadcasting) from the source, wrap around during playback loops, timestamp jumping during creating or encoding the source files such as splicing files, restarting playlists or the source server, or re-synchronization between the bit stream clock, defined by the PCR, and the timestamp.

The discontinuity caused by the missing PTS at the decoder may be detectable by the decoder demultiplexer (demux) from the transport stream. Recovery from the missing PTS at the decoder using the PCR to reset the local system clock in the decoder would require a system clock controller to reset the local system clock and software support. Recovery from the missing PTS at the decoder by the decoder rendering module resetting the local system clock would require a run-time configurable local system clock and software support. Recovery from the missing PTS at the decoder by the decoder demux using a prediction of the missing PTS based on the PTS received before the discontinuity and corrected by a video or audio frame duration can provide erroneous predictions in the case of variable duration samples.

It would be advantageous to have an audio/video decoder in which reliable recovery from a discontinuity in presentation timestamps can be achieved by predicting the missing presentation timestamp(s) without resetting the local system clock in the decoder.

### BRIEF DESCRIPTION OF THE DRAWINGS

The present invention, together with objects and advantages thereof, may best be understood by reference to the following description of embodiments thereof shown in the accompanying drawings. Elements in the drawings are illustrated for simplicity and clarity and have not necessarily been drawn to scale.

FIG. 1 is a schematic block diagram of a video and audio decoder in accordance with an embodiment of the invention;

FIG. 2 is a schematic block diagram of a data processing system that may be used in implementing the multi-core video decoder of FIG. 1;

FIG. 3 is a flow chart of an example of operation of the decoder of FIG. 1;

FIG. 4 is a timing chart of signals appearing in one scenario of operation of the decoder of FIG. 1; and

FIG. 5 is a timing chart of signals appearing in another scenario of operation of the decoder of FIG. 1.

### DETAILED DESCRIPTION

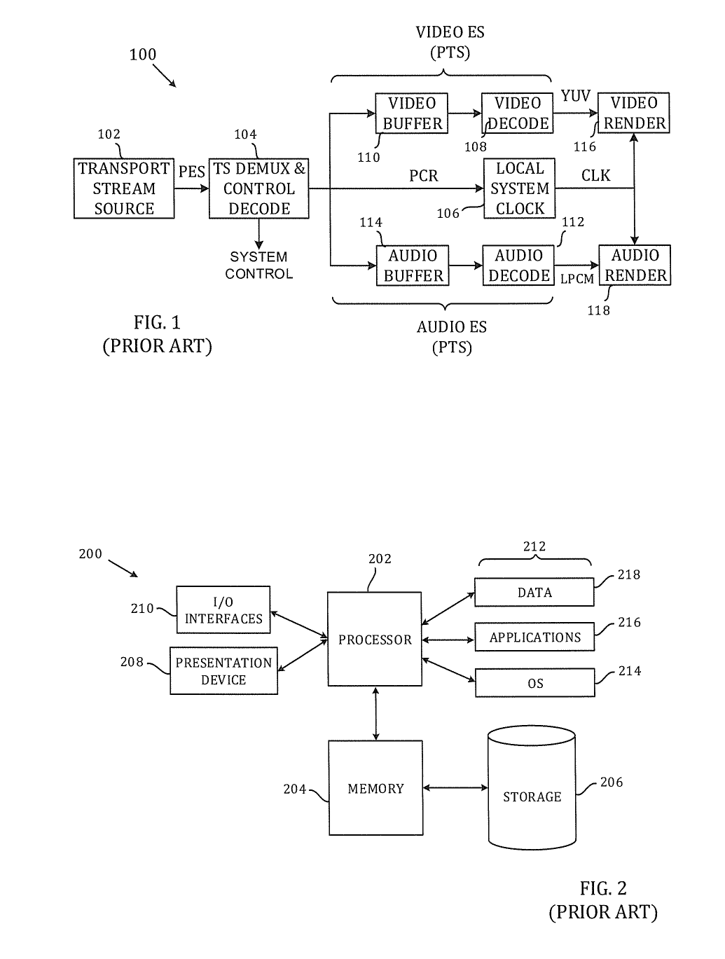

FIG. 1 illustrates a decoder 100 for decoding compressed audio and video data in accordance with an embodiment of the invention. The decoder 100 is described below as used for decoding data compressed according to the ITU-T H.262|ISO/IEC13818 (MPEG2) standards, but it will be appreciated that the decoder 100 can be adapted and used to decode data compressed according to other standards. The decoder 100 decodes a broadcast packetized elementary bit stream (PES) containing compressed video picture and audio data, from a source 102 such as a tuner or from a network. The PES also contains a series of presentation timestamps (PTS) for synchronizing presentation of audio and video and audio data. The decoder 100 comprises a demultiplexer and control decoder module 104 for retrieving elementary bit streams (ES) from the packetized elementary bit stream (PES). The decoder 100 also comprises a local clock 106, and a presentation decoder module that decodes the retrieved elementary bit streams for presentation. The demultiplexer and control decoder module 104 provides video ES to a video decoder 108 through a video buffer 110 and audio ES to an audio decoder 112 through an audio buffer 114. The demultiplexer and control decoder module 104 also provides system control data that it decodes from the PES. The output of the video decoder 108 may be in YUV format, and the output of the audio decoder 112 may be in linear pulse-code modulation (LPCM) format. The video and audio signals have different and varying latencies (the transit times between input to the module 104 and output from the video and audio decoders 108 and 112) and contain the PTS that enable synchronization of the video and audio presentations. The decoded video and audio signals are presented to a viewer on a video render device 116 and an audio render device 118, synchronized by the PTS which identify render times from the clock signals of the local clock 106, which itself is synchronized with the system clock represented by the PCR signals.

FIG. 2 is a schematic block diagram of a data processing system 200 that may be used in implementing the decoder 100. The data processing system 200 includes a processor 202 coupled to a memory 204, which may provide buffers in the parallel decoder 100, and additional memory or storage 206 coupled to the memory 204. The data processing system 200 also includes a presentation device 208, which may be the video render device 116 and audio render device 118 that display the reconstructed picture data and play the audio data, input/output interfaces 210, and software 212. The software 212 includes operating system software 214, applications programs 216, and data 218. The data processing system 200 generally is known in the art except for the algorithms and other software used to implement the decoding of compressed video picture data described above. When software or a program is executing on the processor 202, the processor becomes a “means-for” performing the steps or instructions of the software or application code running on the processor 202. That is, for different instructions and different data associated with the instructions, the internal circuitry of the processor 202 takes on different states due to different register values, and so on, as is known by those of skill in the art. Thus, any means-for structures described herein relate to the processor 202 as it performs the steps of the methods disclosed herein.

In the decoder 100, if a discontinuity occurs in the series of PTS, the demultiplexer and control decoder module 104 provides a prediction TS_{P} of a PTS after the discontinuity that is conditional on whether the last PTS in data of the elementary bit stream is still valid when the discontinuity is detected. In the decoder 100, if the last PTS in data from the elementary bit stream is still valid when a discontinuity occurs in the series of PTS, the demultiplexer and control decoder module 104 provides a prediction TS_{P} of a PTS after the discontinuity that is based on extrapolation from a PTS received prior to detection of the discontinuity using a defined duration T_{DURATION} of sample data in the elementary bit stream. If the last PTS in data from the elementary bit stream has lapsed when the discontinuity is detected, the prediction TS_{P} of the PTS after detection of the discontinuity is based on the current time T_{H} indicated by the local clock 106 extrapolated using a defined duration T_{LATENCY}. A PTS is still valid if the render time TS_{MIN} that it indicates is later than the current time T_{M} (TS_{MIN}>T_{M}) indicated by the local clock 106, and has lapsed if the current time T_{M} indicated by the local clock 106 is already later than the render time TS_{MIN} that the PTS indicates (TS_{MIN}<T_{M}). The validity of a PTS may be defined by whether data is still present in the pipeline 104, 110, 108 from the input of the demultiplexer and control decoder module 104 to an output from the presentation decoder module 108. The prediction TS_{P} based on the current time T_{M} indicated by the local clock may be extrapolated using a defined duration of latency T_{LATENCY} from an output from the demultiplexer and control decoder module 104 to an output from the render module 116, 118.

The demultiplexer and control decoder module 104 may provide the prediction TS_{P} of a first PTS after the discontinuity based on extrapolation using defined data (a PTS received prior to detection of the discontinuity, or the current time indicated by the local clock), and provides an adjustment of a subsequent PTS based on the prediction TS_{P} of the first PTS after the discontinuity. The adjustment of the subsequent PTS may extrapolate the prediction TS_{P} of the first PTS after the discontinuity using a difference (T_{N+1}−T_{N}), (T_{N+2}−T_{N}) between the received values of the subsequent PTS and the first PTS.

When the packetized elementary bit stream PES contain compressed video picture and audio data in different tracks with respective series of PTS, the PTS may be adjusted only if discontinuity is detected in all the series of PTS.

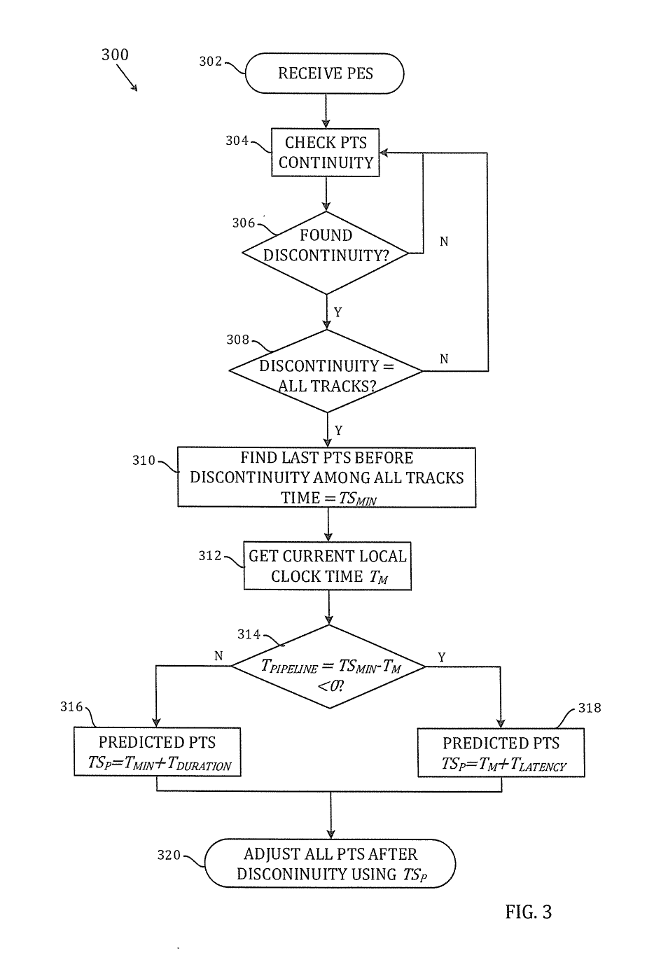

FIG. 3 illustrates a method 300 of operation of an example of the decoder 100. The method 300 starts at 302 with reception of a PES. At 304, the demultiplexer and control decoder module 104 checks the continuity of the PTS in the PES. If no discontinuity is found, the decoder 100 processes decoding the PES and returns to step 304 periodically. If a discontinuity is found at 306, the demultiplexer and control decoder module 104 checks whether the discontinuity concerns all tracks of the PES and, if not, the decoder 100 processes decoding the PES and returns to step 304 periodically. If the discontinuity concerns all tracks of the PES, at 310 the demultiplexer and control decoder module 104 finds the presentation time TS_{MIN} indicated by the last PTS at its input before detecting the discontinuity and also gets the time that the local clock 106 indicates when the discontinuity is detected at 312. At 314, the demultiplexer and control decoder module 104 checks whether data from the elementary bit stream is still present in the pipeline 104, 110, 108 from the input of the demultiplexer and control decoder module 104 to an output from the presentation decoder module 108 to check whether the last PTS received before the discontinuity is still valid, by calculating a parameter T_{PIPELINE}=TS_{MIN}−T_{M}. If T_{PIPELINE} is positive, and therefore the pipeline 104, 110, 108 still has ES data in its buffer, at 316 the prediction TS_{P} of the PTS N after the discontinuity is based on extrapolation from TS_{MIN}, the last PTS received prior to detection of the discontinuity using a defined duration T_{DURATION} of video or audio sample data in the elementary bit stream TS_{P}=TS_{MIN}+T_{DURATION}. If T_{PIPELINE} is negative, and therefore the pipeline 104, 110, 108 no longer has ES data in its buffer, at 318 the prediction TS_{P} of the PTS N after the discontinuity is based on extrapolation from the current time T_{M} indicated by the local clock 106 extrapolated using a defined duration of latency T_{LATENCY} from an output from the demultiplexer and control decoder module 104 at least to an output from the presentation decoder module 108, 112 TS_{P}=T_{M}+T_{LATENCY}. The PTS of all tracks are adjusted on the same basis. Subsequent PTS N+1, N+2, . . . after the PTS N, are adjusted using the prediction TS_{PN} of the PTS N and the difference between the time TS_{N}, and the times TS_{(N+1)}, TS_{(N+2)}, . . . indicated by the successive PTS N, N+1, N+2, . . . :

TS_{P(N+1)}=TS_{PN}+(TS_{(N+1)}−TS_{N})

TS_{P(N+2)}=TS_{PN}+(TS_{(N+2)}−TS_{N}).

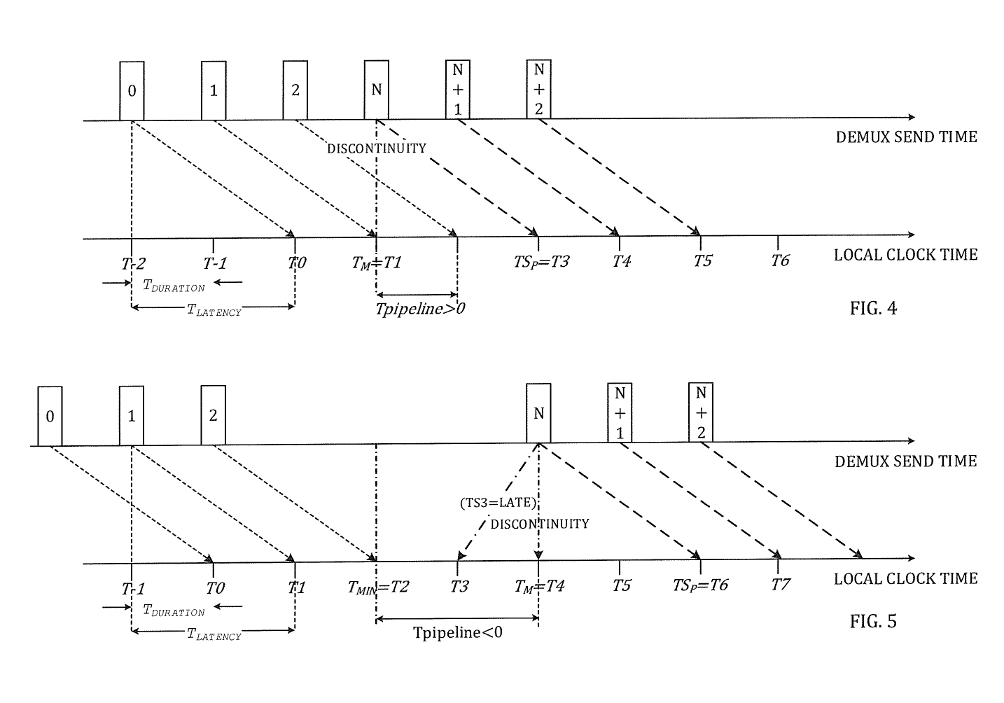

FIGS. 4 and 5 illustrate the method 300 graphically. In each Figure, the upper line of the timing chart represents the time of output into the output buffer of the demultiplexer and control decoder module 104 (and its input, its processing time being assumed negligible) of successive PTS 0, 1, 2, N, N+1, N+2. A discontinuity is detected at a current time T_{M} indicated by the local clock 106 immediately before the PTS N. The duration T_{LATENCY} of the latency from the output from the demultiplexer and control decoder module 104 to the corresponding output from the render module 116, 118 is illustrated by dashed arrows from the upper line of the timing chart to the lower line, which represents the time of presentation indicated by each PTS relative to the local clock 106. The predictions are represented by bold dashed arrows.

FIG. 4 illustrates a scenario where data from the elementary bit stream is still present in the pipeline 104, 110, 108 from the input of the demultiplexer and control decoder module 104 to the output from the presentation decoder module 108 when the discontinuity occurs in the series of PTS at T_{M}, so that the last PTS, 2, in the data from the elementary bit stream is still valid. The demultiplexer and control decoder module 104 calculates the parameter T_{PIPELINE}=TS_{MIN}−T_{M}, where TS_{MIN}=T2, and T_{M} is approximately equal to T1 and T_{PIPELINE} is positive. The prediction TS_{P}=TS_{MIN}+T_{DURATION} of the first PTS N after the discontinuity is based on extrapolation from TS_{MIN}=T2, the last PTS received prior to detection of the discontinuity using the duration T_{DURATION} between successive video sample data in the elementary bit stream, such as (T2−T1). In this scenario, the prediction TS_{P} is approximately equal to T3.

FIG. 5 illustrates a scenario where data from the elementary bit stream is no longer present in the pipeline 104, 110, 108 from the input of the demultiplexer and control decoder module 104 to the output from the presentation decoder module 108 when the discontinuity occurs in the series of PTS at T_{M}, so that the last PTS, 4 (and 3), in the data from the elementary bit stream has lapsed. PTS, starting from 3, are missing (illustrated by a dash-dotted arrow) and do not arrive before the discontinuity is detected. The demultiplexer and control decoder module 104 calculates the parameter T_{PIPELINE}=TS_{MIN}−T_{M}, where TS_{MIN}=T2, and T_{M} is approximately equal to T4, and T_{PIPELINE} is negative. The prediction TS_{P}=T_{M}+T_{LATENCY} of the first PTS N after the discontinuity is based on extrapolation from the current time T_{M} indicated by the local clock 106, extrapolated using the defined duration of latency T_{LATENCY} from an output from the demultiplexer and control decoder module 104, for example at PTS 2 approximately equal to time T0 to a corresponding output from the render module 116, 118 at time T2. In this scenario, the prediction TS_{P} is approximately equal to T6.

The invention may be implemented at least partially in a non-transitory machine-readable medium containing a computer program for running on a computer system, the program at least including code portions for performing steps of a method according to the invention when run on a programmable apparatus, such as a computer system or enabling a programmable apparatus to perform functions of a device or system according to the invention.

The computer program may be stored internally on computer readable storage medium or transmitted to the computer system via a computer readable transmission medium. All or some of the computer program may be provided on non-transitory computer-readable media permanently, removably or remotely coupled to an information processing system. The computer-readable media may include, for example and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM and so on; and data transmission media including computer networks, point-to-point telecommunication equipment, and carrier wave transmission media, just to name a few.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. Similarly, any arrangement of components to achieve the same functionality is effectively “associated” such that the desired functionality is achieved. Hence, any two components combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

In the claims, the word ‘comprising’ or ‘having’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A decoder for decoding a packetized elementary bit stream containing compressed audio and video data and a series of presentation timestamps (PTS) for synchronizing presentation of the audio and video, the decoder comprising:
a demultiplexer and control decoder module for retrieving elementary bit streams from the packetized elementary bit stream;
a local clock; and
a presentation decoder module that decodes the retrieved elementary bit streams for presentation,
wherein, if the last PTS in data from the elementary bit stream is valid when a discontinuity occurs in the series of PTS, the demultiplexer and control decoder module provides a prediction of a PTS after the discontinuity that is based on extrapolation from a PTS received prior to detection of the discontinuity using a defined duration of sample data in the elementary bit stream, and
if the last PTS in data from the elementary bit stream has lapsed when the discontinuity is detected, the prediction of the PTS after detection of the discontinuity is based on the current time indicated by the local clock extrapolated using a defined duration.

2. The decoder of claim 1, wherein the prediction based on the current time indicated by the local clock is extrapolated using a defined duration of latency from an output from the demultiplexer and control decoder module at least to an output from the presentation decoder module.

3. The decoder of claim 1, wherein the demultiplexer and control decoder module provides the prediction of a first PTS after the discontinuity based on extrapolation using defined data, and provides an adjustment of a subsequent PTS based on the prediction of the first PTS after the discontinuity.

4. The decoder of claim 3, wherein the adjustment of the subsequent PTS extrapolates the prediction of the first PTS after the discontinuity using a difference between the received values of the subsequent PTS and the first PTS.

5. The decoder of claim 1, wherein the packetized elementary bit stream contains compressed video picture and audio data in different tracks with respective series of PTS, and the PTS are adjusted only if discontinuity is detected in all the series of PTS.

6. A decoder for decoding a packetized elementary bit stream containing compressed video picture and audio data and a series of presentation timestamps (PTS) for synchronizing presentation of video and audio data, the decoder comprising:
a demultiplexer and control decoder module for retrieving elementary bit streams from the packetized elementary bit stream;
a local clock; and
a presentation decoder module that decodes the retrieved elementary bit streams for presentation,
wherein, if a discontinuity occurs in the series of PTS, the demultiplexer and control decoder module provides a prediction of a PTS after the discontinuity that is conditional on whether the last PTS in data of the elementary bit stream is still valid when the discontinuity is detected.

7. The decoder of claim 6, wherein the demultiplexer and control decoder module provides the prediction of a first PTS after the discontinuity based on extrapolation using defined data, and provides an adjustment of a subsequent PTS based on the prediction of the first PTS after the discontinuity.

8. The decoder of claim 7, wherein the adjustment of the subsequent PTS extrapolates the prediction of the first PTS after the discontinuity using a difference between the received values of the subsequent PTS and the first PTS.

9. The decoder of claim 6, wherein if the last PTS in data from the elementary bit stream is still valid when the discontinuity is detected, the prediction of the PTS after detection of the discontinuity is based on extrapolation from a PTS received prior to detection of the discontinuity using a defined duration of sample data in the elementary bit stream.

10. The decoder of claim 6, wherein if the last PTS in data from the elementary bit stream has lapsed when the discontinuity is detected, the prediction of the PTS after detection of the discontinuity is based on the current time indicated by the local clock extrapolated using a defined duration.

11. The decoder of claim 10, wherein the prediction based on the current time indicated by the local clock is extrapolated using a defined duration of latency from an output from the demultiplexer and control decoder module at least to an output from the presentation decoder module.

12. The decoder of claim 6, wherein the packetized elementary bit stream contains compressed video picture and audio data in different tracks with respective series of PTS, and the PTS are adjusted only if discontinuity is detected in all the series of PTS.

13. A decoder for decoding a packetized elementary bit stream containing compressed video picture and audio data and a series of presentation timestamps (PTS) for synchronizing presentation of video and audio data, the decoder comprising:
a demultiplexer and control decoder module for retrieving elementary bit streams from the packetized elementary bit stream;
a local clock; and
a presentation decoder module that decodes the retrieved elementary bit streams for presentation;
wherein, if a discontinuity occurs in the series of PTS, the demultiplexer and control decoder module provides a prediction of a PTS after the discontinuity that is conditional on whether data of the elementary bit stream is still present in the pipeline from the input of the demultiplexer and control decoder module to an output from the presentation decoder module when the discontinuity is detected, and if data from the elementary bit stream is no longer present in the pipeline when the discontinuity is detected, the prediction of the PTS after detection of the discontinuity is based on the current time indicated by the local clock extrapolated using a defined duration.

14. The decoder of claim 13, wherein the prediction based on the current time indicated by the local clock is extrapolated using a defined duration of latency from an output from the demultiplexer and control decoder module at least to an output from the presentation decoder module.

15. The decoder of claim 13, wherein if data from the elementary bit stream is still present in the pipeline when the discontinuity is detected, the prediction of the PTS after detection of the discontinuity is based on extrapolation from a PTS received prior to detection of the discontinuity using a defined duration of sample data in the elementary bit stream.

16. The decoder of claim 13, wherein the demultiplexer and control decoder module provides the prediction of a first PTS after the discontinuity based on extrapolation using defined data, and provides an adjustment of a subsequent PTS based on the prediction of the first PTS after the discontinuity.

17. The decoder of claim 16, wherein the adjustment of the subsequent PTS extrapolates the prediction of the first PTS after the discontinuity using a difference between the received values of the subsequent PTS and the first PTS.

18. The decoder of claim 13, wherein the packetized elementary bit stream contains compressed video picture and audio data in different tracks with respective series of PTS, and the PTS are adjusted only if discontinuity is detected in all the series of PTS.
